(19) United States
(12) Patent Application Publication
(10) Pub. No.: US 2024/0123504 A1
(43) Pub. Date: Apr. 18, 2024

(54) PRINTING A THREE-DIMENSIONAL PART TO ENHANCE SEPARATION AND SYSTEM AND METHODS THEREOF

(71) Applicant: XEROX CORPORATION, Norwalk, CT (US)

(72) Inventors: Varun Sambhy, Pittsford, NY (US); Seemit Praharaj, Webster, NY (US); Jason M. LeFevre, Penfield, NY (US); Douglas K. Herrmann, Webster, NY (US)

(73) Assignee: XEROX CORPORATION, NORWALK, CT (US)

(21) Appl. No.: 18/047,371

(22) Filed: Oct. 18, 2022

(51) Int. Cl. B22F 10/62; B22D 23/00; B22F 10/22; B22F 12/20; B22F 12/53; B33Y 10/00; B33Y 30/00; B33Y 40/20

(52) U.S. Cl. CPC B22F 10/62; B22D 23/003; B22F 10/22; B22F 12/20; B22F 12/53; B33Y 10/00; B33Y 30/00; B33Y 40/20; B22F 2301/052

(57) ABSTRACT

A printing system and method of forming a three-dimensional printed part in a printing system is disclosed, including forming a three-dimensional printed part in a printing system includes depositing a first print material onto a substrate or a partially formed three-dimensional metal part, depositing a second print material may include an oxidizing agent onto the partially formed three-dimensional part, and forming an oxidized layer on a top surface of the partially formed three-dimensional part.

### TECHNICAL FIELD

The present teachings relate generally to liquid ejectors in drop-on-demand (DOD) printing and, more particularly, to methods and apparatus for printing three-dimensional parts for use within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, for example, one that prints a metal or metal alloy, ejects a small drop of liquid aluminum alloy when a firing pulse is applied. Using this technology or others using various printing materials, a 3D part can be created by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

Furthermore, during the printing process of molten aluminum by the certain printers, there is currently no means to produce a removable support structure. Without a supplementary support system, the printer is unable to print accurate parts with overhangs beyond 45 degrees. This challenges the capability of the printing system to build many shapes and features such as vertical holes and bridge forms. While other types of additive manufacturing provide for support function either through additional materials or other means of producing removable supports, it would be advantageous to reduce significant secondary processes to machine material out and remove support structures from completed build parts.

Therefore, it is desirable for a printing method, printing system, or build material that can be utilized to provide removable support structures for three-dimensional printed objects or parts.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of forming a three-dimensional printed part in a printing system is disclosed. The method of forming a three-dimensional printed part in a printing system includes depositing a first print material onto a substrate or a partially formed three-dimensional metal part, depositing a second print material may include an oxidizing agent onto the partially formed three-dimensional part, and forming an oxidized layer on a top surface of the partially formed three-dimensional part.

Implementations of the method of forming a three-dimensional printed part in a printing system includes separating a first portion of the three-dimensional part from a second portion of the three-dimensional part. The first portion may include a support layer. The first portion may include a completed three-dimensional part. The method may include exposing the partially formed three-dimensional metal part to an elevated temperature to oxidize the second print material. The method may include exposing the partially formed three-dimensional metal part to a reducing agent to oxidize the second print material. The first print material may include the reducing agent. The method may include depositing the first printing material onto the oxidized layer on the top surface of the partially formed three-dimensional part after forming the oxidized layer on a top surface of the partially formed three-dimensional part. The oxidizing agent may include a hypochlorite, a chlorite, a chlorate, a perchlorate, or a combination thereof. The oxidizing agent may include a hexavalent chromium compound. The oxidizing agent may include a permanganate. The first print material may include aluminum.

A method of forming a separation layer for a three-dimensional printed part in a printing system is disclosed. The method of forming a separation layer includes depositing an oxidizing print material onto a first portion of a three-dimensional part may include a build material, evaporating a volatile portion of the print material, depositing build material onto the print material to form a second portion of the three-dimensional part, and separating the first portion of the three-dimensional part from the second portion of the three-dimensional part. Implementations of the method of forming a separation layer for a three-dimensional printed part in a printing system may include where the oxidizing print material may include a hypochlorite, a chlorite, a chlorate, a perchlorate, or a combination thereof. The oxidizing print material may include a hexavalent chromium compound. The oxidizing print material may include a permanganate.

A printing system is disclosed. The printing system includes a first ejector for jetting a first print material, including a coil wrapped at least partially around the ejector, a power source configured to transmit voltage pulses to the coil and configured to supply one or more pulses of power to the coil, which causes one or more drops of the first printing material to be jetted out of the first ejector, and a second ejector for jetting a second print material, where the second print material may include an oxidizing agent.

Implementations of the printing system may include where the second print material may include hypochlorite, a chlorite, a chlorate, a perchlorate, a hexavalent chromium compound, a permanganate, or a combination thereof. The second ejector may include a piezoelectric element configured to jet one or more drops of the second printing material from the second ejector. The second ejector may include a solenoid element configured to jet one or more drops of the second printing material from the second ejector. The second ejector may include a cooling element.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIG. 2 depicts a view of several having several geometrical features that reflect some challenges with printing of a three-dimensional printed part, in accordance with the present disclosure.

FIG. 3 depicts a schematic process for printing three-dimensional printed parts with the use of a separation layer, in accordance with the present disclosure.

FIG. 4A-4C depict cross-sectional side views of an ejector and nozzle for printing a separation layer, in accordance with the present disclosure.

FIGS. 5A-5C depict several views of a printing system for forming a three-dimensional printed part having a separation layer, in accordance with the present disclosure.

FIGS. 6A-6E depict several views of the formation of a three-dimensional printed part having a separation layer, in accordance with the present disclosure.

FIG. 7 is a flowchart illustrating a method for forming a three-dimensional printed part in a printing system, in accordance with the present disclosure.

FIG. 8 is a flowchart illustrating a method for forming a separation layer for a three-dimensional printed part in a printing system, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary examples of the present teachings, examples of which are illustrated in the accompanying drawings. Wherever possible, the same reference numbers will be used throughout the drawings to refer to the same, similar, or like parts.

Examples of the present disclosure provide a hybrid printing approach that enables the printing of metal three-dimensional parts or components with a drop on demand inkjet application of a separation layer printing material suspension including an oxidative ink component. The separation layer printing material suspension can be jetted directly onto a metal printed part at any stage to oxidize the targeted or selected surface of the part and also oxidizes any subsequent drop that lands on the targeted surface having an oxidative ink. One such example includes a case where aluminum metal is oxidized to aluminum oxide by contact with the separation layer composition. Another illustrative example includes magnesium metal being oxidized to magnesium oxide. Thus, a thin layer of the ‘separating’ oxide results in the ink targeted areas which acts as a separating layer. The oxide separating layer facilitates easy removal of a printed support structure or other feature in a three-dimensional metal printer. A hybrid print process as described, combining the existing liquid metal printing with a drop on demand inkjet application of an oxidative ink dispersion can produce an oxidized layer with reduced physical integrity as compared to a build material not exposed to the oxidative ink. An oxidized layer can act as a separating layer from one or more support structures that can be printed with the same metal build material. Such a separating layer facilitates easy removal of the printed support structures from a completed part. In certain examples, a similar thermal conductivity the build material and the separation layer material ensures consistency with respect to the integrity of the build part.

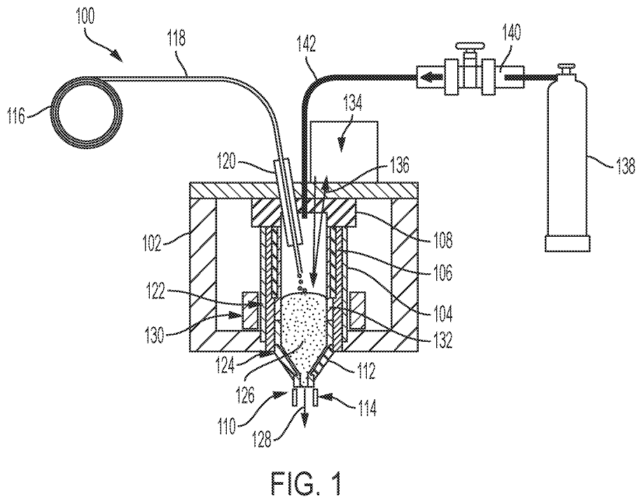

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 can be defined as an inner volume 132 (also referred to as an internal cavity or an inner cavity). The ejector 104 can be defined as a structure that can be selectively activated in such a manner as to cause a build material, print material to be ejected from a nozzle 110 of the ejector. The nozzle 110 can be defined as a physical structure of the ejector from which a build material or print material takes flight. A printing material 126 may be introduced into the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, that is positioned proximate to (e.g., below) the nozzle 110. The substrate may include a heating element, or alternatively be constructed of brass or other materials. In certain examples, the substrate may further include a build plate made of brass which can be coated with nickel to promote the wetting of molten aluminum droplets when they impinge on the build plate. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another example, there may be relative rotation between the nozzle 110 and the substrate around one or two additional axes, such that there is four or five axis position control. In certain examples, both the nozzle 110 and the substrate may move. For example, the substrate may move in X and Y directions, while the nozzle 110 moves up and/or down in a Z direction. In case of a nozzle 110 moving, the nozzle 110 and other printhead assembly components can include a nozzle or printhead motor control, not shown herein.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate, additional system elements, or a combination thereof may be positioned at least partially within the enclosure 102. In another example, the ejector 104, the heating elements 112, the power source, the coils, the substrate, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein may alternatively include other printing materials such as plastics or other ductile materials that are non-metals. The print material may include a metal, a metallic alloy, or a combination thereof. A non-limiting example of a printing material may include aluminum. Exemplary examples of printing systems of the present disclosure may include an ejector for jetting a print material, including a structure defining an inner cavity, and a nozzle orifice in connection with the inner cavity and configured to eject one or more droplets of liquid print material, wherein the ejector is configured to print a first layer of a three-dimensional printed part from a standoff position relative to the substrate and the ejector is configured to print one or more remaining layers onto the first layer from a z-height position relative to a top surface of the first layer.

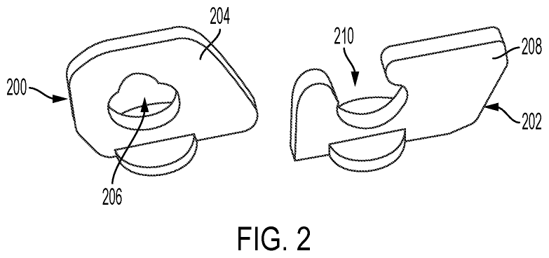

FIG. 2 depicts a view of several having several geometrical features that reflect some challenges with printing of a three-dimensional printed part, in accordance with the present disclosure. In an exemplary example of a system that builds 3D parts, molten aluminum alloy is used as a primary build material. As described herein, the printing system works by using a DC pulse applied by an electromagnetic coil to expel molten aluminum drops in response to a series of voltage pulses. The platen or substrate to which the drops are targeted allows for the drops to be connected and built up to produce a three-dimensional part. In the parts shown in FIG. 2, the parts 200, 202 are being built with drops exiting the nozzle at ˜400 Hz. The materials used in the examples include Al 6061, 356, 7075 and 4043. The expected drop size is approximately 0.5 mm as ejected and nominally spreads to approximately 0. 7 mm upon contact with the part surface during the optimal build of the part. The printing system is limited in terms of capability due to the lack of support structures to buttress the build part. Consequently, the resulting parts need extensive machining to produce a final usable part. As shown in FIG. 2, one part 200 has a portion 204 with a lack of support structure, which results in a deformed opening 206 in the part 200. Likewise, in the other part 202, there also exists a portion 208, which also lacks support and similarly, this also results in a deformed opening 210 due to a lack of support combined with the angle of the portion 208 of the part 202 and its combination with existing gravitational forces, among other physical phenomena while the part 202 is being formed.

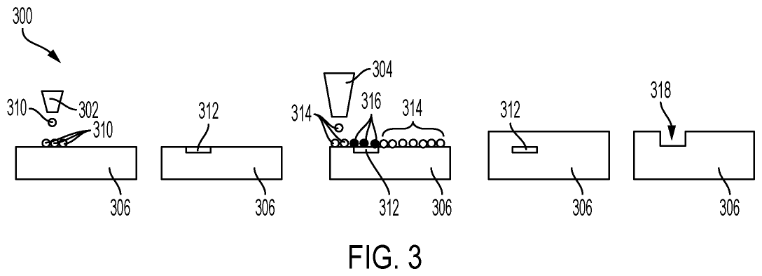

FIG. 3 depicts a schematic process for printing three-dimensional printed parts with the use of a separation layer, in accordance with the present disclosure. The hybrid print process of the present disclosure combines an existing liquid metal printing process and assembly with a drop on demand inkjet application of a separation layer printing material. An illustrative example includes an oxidative ink suspension or dispersion. The oxidative ink suspension may be composed of oxidant salts in a liquid base forming a stable dispersion or solution. The liquid will evaporate upon jetting leaving behind the salt oxidant which then rapidly oxidizes Al, Mg, or other metals or alloys thereof at high temperatures resulting in formation of the separation layer. Common oxidant salts for use in oxidative inks of the present disclosure include, but are not limited to hypochlorite, chlorite, chlorate, perchlorate, and other analogous halogen compounds like household bleach (NaClO), hexavalent chromium compounds such as chromic and dichromic acids and chromium trioxide, pyridinium chlorochromate (PCC), and chromate/dichromate compounds, permanganate compounds such as potassium permanganate (KMnO₄), sodium perborate, potassium nitrate (KNOB), sodium bismuthate (NaBiO₃), cerium (IV) compounds such as ceric ammonium nitrate and ceric sulfate, lead dioxide (PbO₂), sodium dichromate (Na₂Cr₂O₇), or combinations thereof.

The separation layer printing material can include a liquid base which may include a solvent or evaporable material that leaves an oxidative material or other separation layer material when evaporated. The liquid base can include, but may not be limited to, solvents, for example, water, propane diol, hexanediol, butanediol, glycerol, ethanol, isopropyl alcohol, glycol ethers, or combinations thereof. The hybrid printing system and method 300, shows a secondary separation layer material ejector nozzle 302, depositing a plurality of separation layer material drops 310 onto a three-dimensional part 306 in progress to form an oxidative ink separation layer 312, which is integrated into the three-dimensional part 306 and is oxidized 316 with exposure to elevated temperature or other environmental conditions. Next, a primary build material ejector nozzle 304 ejects a plurality of alloy build material drops 314 over the separation layer 312, with additional alloy build material drops 314 completing the formation of the left in three-dimensional part 306. After formation of the three-dimensional part 306, a gap 316 created by the separation layer 312 can facilitate removal of material deposited onto the separation layer 312. The liquid base will evaporate upon jetting, leaving behind the oxidative ink composition to provide the separation layer 312.

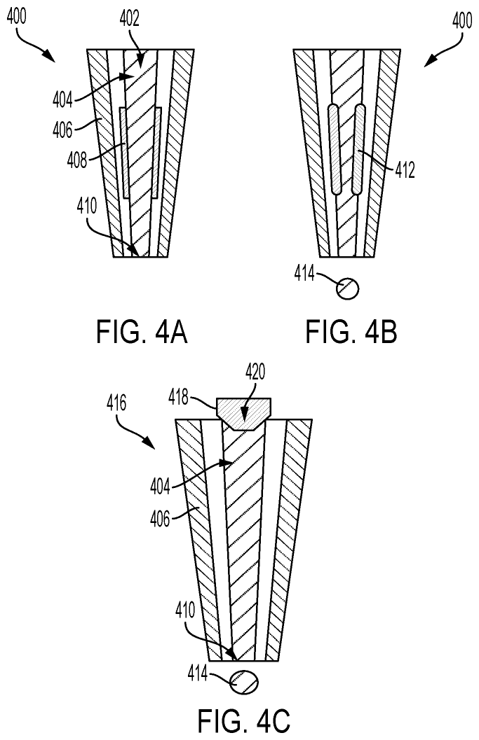

FIG. 4A-4C depict cross-sectional side views of an ejector and nozzle for printing a separation layer, in accordance with the present disclosure. A pressure pulse type droplet ejection mechanism can be used to eject a suitable separation layer material directly onto one or more selective positions on a build part to compose the separation layer. In general, fine ceramic materials having wide temperature stability would be suitable materials for the exterior of an ejector nozzle 400. An interior volume of the nozzle 400 suitable for containing separation layer material 404 provided from a separation layer material supply 402 could be used. Additionally, a cooling element such as a cooling jacket 406 protects the nozzle 400 interior and the associated features from excessive or damaging temperature exposure. FIGS. 4A and 4B depicts a nozzle 400 employing one or more piezoelectric elements 408 on either side of or surrounding the nozzle 400, which can be activated by an electrical pulse. Once the nozzle 400 has one or more active piezoelectric elements 412, it causes the nozzle 400 to eject a drop 414 of the separation layer material 404 from a nozzle orifice 410 to form a separation layer that can be integrated into a three-dimensional part. FIG. 4C shows an alternative ejector nozzle 416 which is a pneumatic device, such as a solenoid element, having an ink supply and pressure control 420 for activating the ejection of one or more drops 414 of the separation layer material 404, which is held in an interior volume of the nozzle 400 and provided from the ink supply and pressure control 420 for the ejector nozzle 416. In this manner, a piezoelectric or pneumatic valve-controlled actuator may be used for discrete droplet generation in a hybrid print process of the present disclosure.

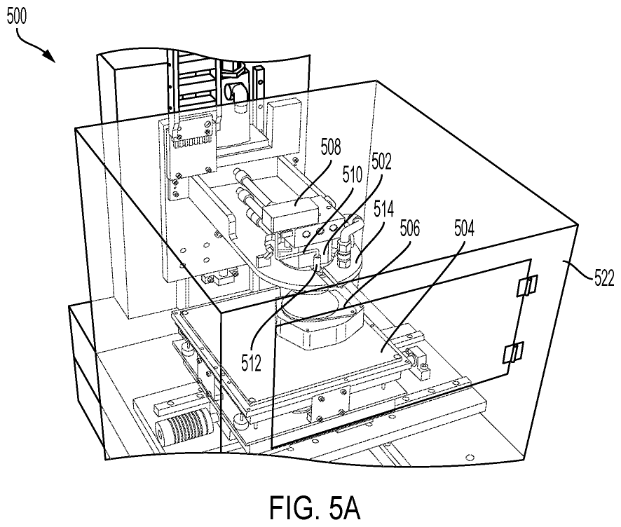

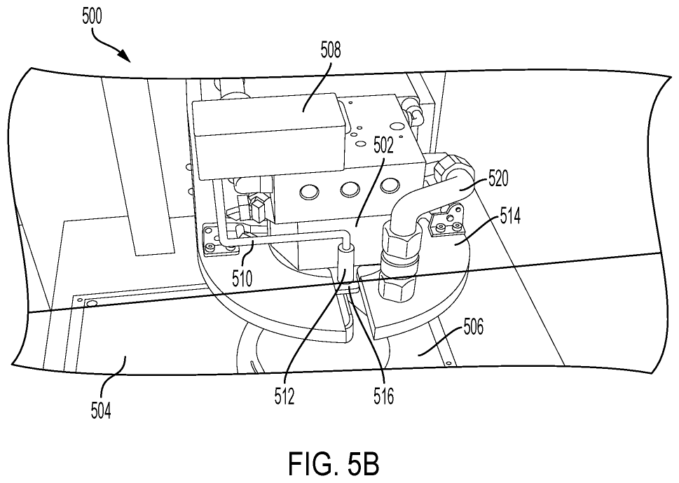

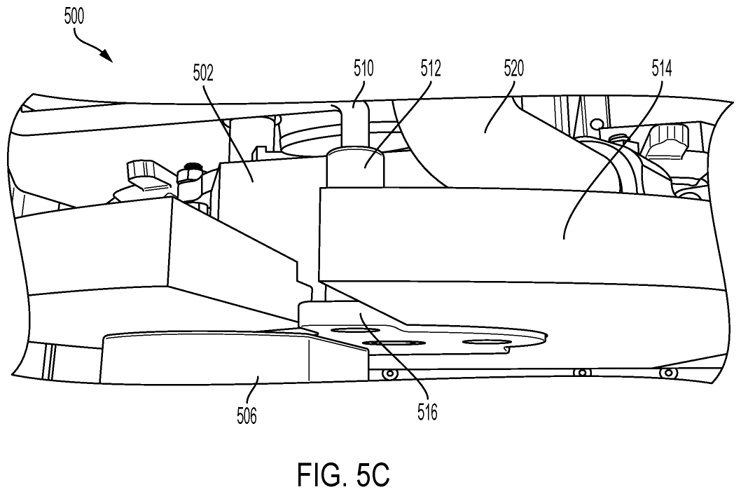

FIGS. 5A-5C depict several views of a printing system for forming a three-dimensional printed part having a separation layer, in accordance with the present disclosure. FIG. 5A shows an isometric view of a hybrid printing system 500, including a substrate 504, a primary build material (metal alloy) ejector assembly 502 in progress of printing a three-dimensional part 506. Also included in the hybrid printing system 500 is a separation layer material supply 508, which is connected to a separation layer material supply line 510 or conduit, which provides separation layer material to a separation layer ejector assembly 512. The primary build material ejector assembly 502, separation layer material supply 508, separation layer material supply line 510, and separation layer ejector assembly 512 are integrated into an x-y translation stage 514, which also includes a thermal shield 516. While shown in this configuration, other arrangements or configurations of a hybrid printing system including both a primary build material ejector assembly 502 and a separation layer ejector assembly 512 may be employed. FIGS. 5B and 5C each show different points of view at different enlargement levels of the hybrid printing system 500.

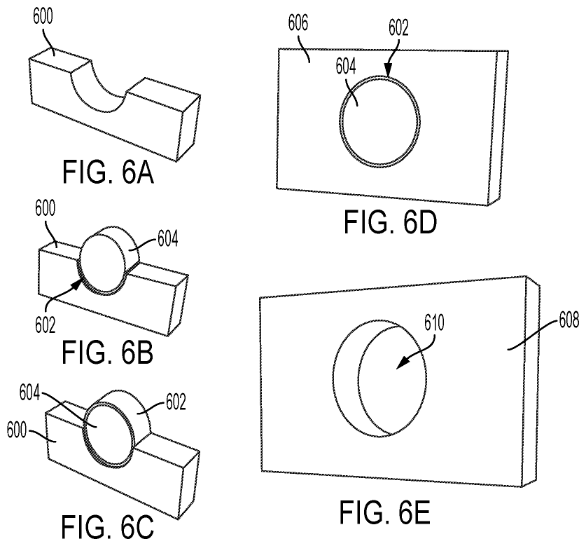

FIGS. 6A-6E depict several views of the formation of a three-dimensional printed part having a separation layer, in accordance with the present disclosure. An initial build part 600 is shown in FIG. 6A. In FIG. 6B, a separation layer 602 is shown printed onto a top surface of the initial build part 600, which is followed by subsequent printing of a printed support structure 604. FIG. 6C shows an additional layer of separation layer 602 printed onto a top surface of the printed support structure 604, with FIG. 6D showing a completed build portion 606, with the separation layer 602 and the printed support structures 604 included therein. FIG. 6E shows a completed build part 608 with a void 610 where the printed support structures 604 has been removed. As noted, before, the separation layer 602, in this example, an oxidative ink, once jetted on to the build part 600 facilitates convenient removal of the printed support structures 604. The ability to print and separate support structures 604 opens significant latitude in the geometries of the available build parts 608. The completed build part 608 shown in FIG. 6E demonstrates an example of a build part 608 that would otherwise not have been possible without the use of a separation layer 602.

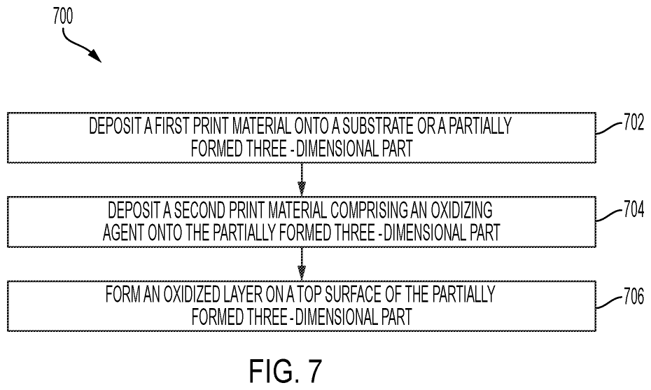

FIG. 7 is a flowchart illustrating a method for forming a three-dimensional printed part in a printing system, in accordance with the present disclosure. A method of forming a three-dimensional printed part in a printing system 700 begins with depositing a first print material onto a substrate or a partially formed three-dimensional part 702, followed by depositing a second print material including an oxidizing agent onto the partially formed three-dimensional part 704. Next, an oxidized layer is formed on a top surface of the partially formed three-dimensional part 706. In certain examples, the first portion can be a support layer. The first print material may be deposited directly onto a substrate of a printing system to form an initial layer or portion of a three-dimensional part. Alternatively, the first print material may be deposited onto the initial layer of the print material that forms the initial layer, such that subsequent layers of the three-dimensional part are built by continued operation of the printer. The method of forming a three-dimensional printed part in a printing system 700 can further include separating a first portion of the three-dimensional part from a second portion of the three-dimensional part, elevating a temperature of the partially formed three-dimensional metal part to oxidize the second print material, and also depositing the first printing material onto the second printing material after allowing the liquid base in the second print material to oxidize. In certain examples, the method of forming a three-dimensional printed part in a printing system 700 can include where the first portion includes a completed three-dimensional part. Alternatively, the method of forming a three-dimensional printed part in a printing system 700 includes exposing the partially formed three-dimensional metal part to a reducing agent to oxidize the second print material, where the reducing agent is included in the first print material. The method of forming a three-dimensional printed part in a printing system 700 can include depositing the first printing material onto the oxidized layer on the top surface of the partially formed three-dimensional part after forming the oxidized layer on a top surface of the partially formed three-dimensional part.

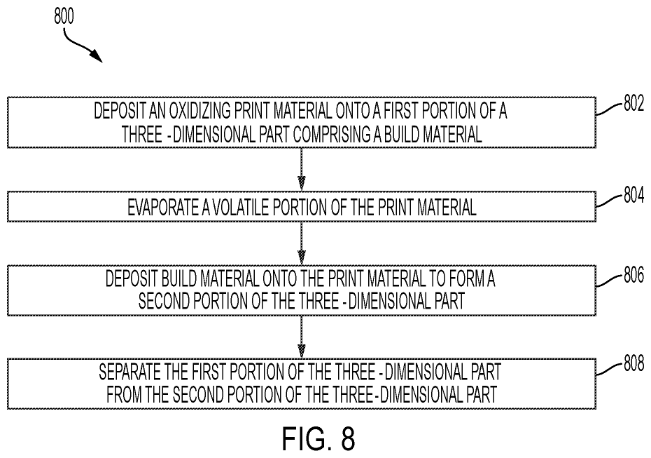

FIG. 8 is a flowchart illustrating a method for forming a separation layer for a three-dimensional printed part in a printing system, in accordance with the present disclosure. A method of forming a separation layer for a three-dimensional printed part in a printing system 800, includes depositing an oxidizing print material onto a first portion of a three-dimensional part comprising a build material 802, evaporating a volatile portion of the print material 804, depositing build material onto the print material to form a second portion of the three-dimensional part 806, followed by separating the first portion of the three-dimensional part from the second portion of the three-dimensional part 808. The oxidizing print material may include hypochlorite, a chlorite, a chlorate, a perchlorate, hexavalent chromium compound, permanganate, other materials as described herein, or a combination thereof. This separation layer as described in the present disclosure printed between a part build and any support structures facilitates easy removal of the support structures. This provides increased latitude in design of the build parts based on the ability to print support structures which are easily removed. Additionally, a fine printing resolution of the separation layer can be realized due to the use of available drop-on-demand inkjet ejector nozzles used in the hybrid printing system.

The present teachings provide a hybrid drop-on-demand inkjet application which can be used to digitally generate a separation layer to a three-dimensional liquid metal printed build part. An oxide separation layer between a build part and a support structure facilitates easy removal of support structures. This can provide increased latitude in design of the build parts based on the capability to print support structures that are easily separable. The present teachings further provide a hybrid printing system having fine resolution of the separation layer due to the use of a drop-on-demand inkjet deposition system. The jettable oxidative ink used to generate the oxide separation layer in selective regions can utilize a ceramic nozzle design with a cooling jacket to enable operation in a high temperature environment associated with metal jet printing.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of forming a three-dimensional printed part in a printing system, comprising:
depositing a first print material onto a substrate or a partially formed three-dimensional metal part;
depositing a second print material comprising an oxidizing agent onto the partially formed three-dimensional part; and
forming an oxidized layer on a top surface of the partially formed three-dimensional part.

2. The method of claim 1, further comprising separating a first portion of the three-dimensional part from a second portion of the three-dimensional part.

3. The method of claim 2, wherein the first portion comprises a support layer.

4. The method of claim 2, wherein the first portion comprises a completed three-dimensional part.

5. The method of claim 1, further comprising exposing the partially formed three-dimensional metal part to an elevated temperature to oxidize the second print material.

6. The method of claim 1, further comprising exposing the partially formed three-dimensional metal part to a reducing agent to oxidize the second print material.

7. The method of claim 6, wherein the first print material comprises the reducing agent.

8. The method of claim 1, further comprising depositing the first printing material onto the oxidized layer on the top surface of the partially formed three-dimensional part after forming the oxidized layer on a top surface of the partially formed three-dimensional part.

9. The method of claim 1, wherein the oxidizing agent comprises a hypochlorite, a chlorite, a chlorate, a perchlorate, or a combination thereof.

10. The method of claim 1, wherein the oxidizing agent comprises a hexavalent chromium compound.

11. The method of claim 1, wherein the oxidizing agent comprises a permanganate.

12. The method of claim 1, wherein the first print material comprises aluminum.

13. A method of forming a separation layer for a three-dimensional printed part in a printing system, comprising:
depositing an oxidizing print material onto a first portion of a three-dimensional part comprising a build material;
evaporating a volatile portion of the print material;
depositing build material onto the print material to form a second portion of the three-dimensional part; and
separating the first portion of the three-dimensional part from the second portion of the three-dimensional part.

14. The method of claim 13, wherein the oxidizing print material comprises a hypochlorite, a chlorite, a chlorate, a perchlorate, or a combination thereof.

15. The method of claim 13, wherein the oxidizing print material comprises a hexavalent chromium compound.

16. The method of claim 13, wherein the oxidizing print material comprises a permanganate.

17. A printing system, comprising:
a first ejector for jetting a first print material, comprising:
a coil wrapped at least partially around the ejector; and
a power source configured to transmit voltage pulses to the coil and configured to supply one or more pulses of power to the coil, which causes one or more drops of the first printing material to be jetted out of the first ejector; and
a second ejector for jetting a second print material, wherein the second print material comprises an oxidizing agent.

18. The printing system of claim 17, wherein the second print material comprises hypochlorite, a chlorite, a chlorate, a perchlorate, a hexavalent chromium compound, a permanganate, or a combination thereof.

19. The printing system of claim 17, wherein the second ejector comprises a piezoelectric element configured to jet one or more drops of the second printing material from the second ejector.

20. The printing system of claim 17, wherein the second ejector comprises a solenoid element configured to jet one or more drops of the second printing material from the second ejector.

21. The printing system of claim 17, wherein the second ejector comprises a cooling element.
